(19) United States
(12) Patent Application Publication
(10) Pub. No.: US 2022/0306432 A1
(43) Pub. Date: Sep. 29, 2022

(54) Ejector for a Forestry Winch

(71) Applicant: Bernward Welschof, Grossostheim (DE)

(72) Inventors: Michael Willenbücher, Oberzent (DE); Claus Hofmann, Haibach (DE); Bernward Welschof, Grossostheim (DE)

(21) Appl. No.: 17/702,614

(22) Filed: Mar. 23, 2022

(30) Foreign Application Priority Data
Mar. 25, 2021 (DE) 10 2021 107 516.5

(51) Int. Cl. B66D 1/36

(52) U.S. Cl. CPC B66D 1/36; B66D 2700/0191

(57) ABSTRACT

An ejector for a forestry winch, the ejector may include a rotating ejector roller by means of which a synthetic rope is guided and deflected, wherein the ejector has at least one rotating pressure roller driven by a drive motor and by means of which the synthetic rope is pressed against the ejector roller.

### CROSS REFERENCE TO RELATED APPLICATIONS

This application claims priority to German Patent Application No. 10 2021 107 516.5, filed Mar. 25, 2021, the disclosure of which is incorporated in its entirety by reference.

### BACKGROUND OF THE INVENTION

### Field of the Invention

The disclosure relates to an ejector for a forestry winch, wherein the ejector has a rotating ejector roller by means of which a synthetic rope is guided and deflected.

### Description of Related Art

Known forestry winches include models with a steel rope and a synthetic rope.

On forestry winches with a steel rope, it is known that a rope located on a rope drum of the forestry winch can be guided by an ejector roller of an ejector, whereby the ejector roller is actively driven by means of a drive motor. With the ejector roller driven by the drive motor, as the steel rope is being unspooled from the rope drum and as the steel rope is being taken up on the rope drum, a desired axial force and thus a rope tension can be applied to the steel rope, which makes possible a safe and correct unspooling of the steel rope from the rope drum when the rope is being unspooled and a safe and correct take-up of the steel rope on the rope drum when the rope is being taken up. With the axial force and thus the rope tension applied to the steel rope by the driven ejector roller, less effort is also required on the part of an operator who must pull the steel rope over a significant distance of up to 100 m as the steel rope is being unspooled from the rope drum. One disadvantage of forestry winches with a steel rope, however, is the heavy weight of the steel rope, which requires a great deal of effort on the part of the operator to carry the steel rope as the steel rope is being unspooled.

Forestry winches with a synthetic rope are also known. A synthetic rope is a textile rope with a dimensionally unstable, flexible synthetic fiber structure, the advantage of which over a steel rope is its lower weight. Furthermore, smaller deflection radii become possible when a synthetic rope is being wound up under no load onto the rope drum of the forestry winch. A significant advantage of forestry winches with a synthetic rope over forestry winches with a steel rope lies in the significantly lower weight of the synthetic rope, as a result of which, when the synthetic rope is being unspooled, significantly less effort is required on the part of the operator to carry the synthetic rope.

However, known ejectors for forestry winches with a steel rope are not suitable for a forestry winch with a synthetic rope. The reason for this unsuitability is that the ejector roller is made of steel, so that there are very poor force transmission levels for the pairing of a steel ejector roller and synthetic rope, so that with the ejector roller driven by the drive motor, sufficient axial forces cannot be transmitted to the synthetic rope to achieve the desired low effort required on the part of the operator to pull the synthetic rope as the synthetic rope is being unspooled. On account of the lower force transmission levels between the driven ejector roller, which is a steel roller, and a synthetic rope, slipping also occurs between the driven ejector roller and the synthetic rope, which quickly results in damage to the synthetic rope.

### SUMMARY OF THE INVENTION

The object of this disclosure is to make available an ejector for a forestry winch which is suitable for use with a synthetic rope and eliminates the above mentioned disadvantages.

The disclosure accomplishes this object in that the ejector has at least one pressure roller that is driven in rotation by means of a drive motor and by means of which the synthetic rope is pressed against the ejector roller.

The disclosure therefore teaches that, on a forestry winch with a synthetic rope, the ejector roller is not driven, but a rotating pressure roller is actively driven by means of a drive motor which presses the synthetic rope against the ejector roller, so that the axial forces and thus the rope tension are transmitted to the synthetic rope and generated on the synthetic rope not by a drive of the ejector roller but by a drive of the pressure roller. The pressure roller driven by the drive motor therefore presses the synthetic rope against the ejector roller and generates the axial force on the synthetic rope. The driven pressure roller with which the necessary axial forces are transmitted to the synthetic rope makes it possible to design the ejector roller in the form of a steel roller which only has to perform the function of a deflection roller to deflect the synthetic rope. Because the function of the ejector roller having the deflector roller is to transmit the high nominal operating forces, the ejector roller is advantageously in the form of a stable steel roller. The resulting disadvantage, that the pairing of a steel ejector roller and synthetic rope results in very poor force transmission levels, is overcome by the disclosure in that the axial forces on the synthetic rope are applied not by the ejector roller which is actively driven by means of a drive motor, but by the pressure roller which is actively driven by the drive motor, because the pressure roller can be realized in a simple manner that results in good force transmission levels for the transmission of force to the synthetic rope. Overall, therefore, an ejector is made available that is suitable and serviceable for use with a synthetic rope and makes it possible to transmit sufficient axial forces to the synthetic rope to achieve the desired reduction in operator effort required to pull the synthetic rope during the unspooling of the synthetic rope.

In one advantageous embodiment of the disclosure, the surface of the pressure roller by means of which the pressure roller is in contact with the synthetic rope is rubberized. When the surface of the pressure roller is rubberized, good force transmission levels from the pressure roller driven by means of the drive motor to the synthetic rope can be achieved in a simple manner, as a result of which sufficient axial forces can be transmitted in a simple manner from the driven pressure roller to the synthetic rope to achieve the desired reduction in operator effort required to pull the synthetic rope during the unspooling of the synthetic rope.

In one advantageous development of the disclosure, the pressure roller actively driven by means of the drive motor and the ejector roller are rotationally coupled. This rotational coupling makes it possible for the ejector roller not to be rotated and therefore driven by the synthetic rope, but so that it is rotated and therefore driven by the pressure roller which is actively driven by the drive motor, as a result of which a secure drive of the ejector roller can be achieved that results in low wear on the synthetic rope and the ejector roller.

In one configuration, for this rotational coupling a transmission, for example a chain or belt drive, can be provided between the pressure roller driven by the drive motor and the ejector roller to drive the ejector roller by means of the pressure roller. Alternatively, a gearing that is not sensitive to radial tolerances can be provided between the pressure roller driven by the drive motor and the ejector roller, so that the ejector roller is entrained and driven by the pressure roller.

In one advantageous embodiment of the disclosure, a transmission of force is provided between the actively driven pressure roller and the ejector roller for the drive of the ejector roller by the pressure roller. With a transmission of force, in a particularly simple embodiment, an entrainment of the ejector roller and thus a drive of the ejector roller by the actively driven pressure roller can be achieved.

According to one development of the disclosure, at least one additional pressure roller not actively driven by means of a drive motor can be provided, by means of which the synthetic rope is pressed against the ejector roller.

The pressure roller not actively driven by means of a drive motor can be in the form of a passive following pressure roller.

According to one advantageous development of the disclosure, the additional pressure roller and the ejector roller are rotationally coupled. Preferably there is a transmission of force between the ejector roller and the at least one additional pressure roller which is not actively driven by means of a drive motor for the drive of the additional pressure roller by the ejector roller. The pressure roller which is not actively driven by means of a drive motor is therefore driven by the transmission of force from the ejector roller, which is in turn driven by the pressure roller which is actively driven by means of the drive motor, for example by means of a transmission of force. This combination of ejector and pressure rollers therefore represents a friction gearing.

According to one advantageous embodiment of the disclosure, the pressure roller and/or the optional additional pressure roller have a rubberized surface, by means of which the pressure roller and/or the optional additional pressure roller is in contact with the ejector roller. With a rubberized surface, good force transmission levels can be achieved for a transmission of force from the pressure roller driven by means of the drive motor to the ejector roller to be driven by the pressure roller, or from the ejector roller to the additional pressure roller to be driven by the ejector roller.

According to one advantageous embodiment of the disclosure, the ejector roller has a locator groove for the synthetic rope, whereby the locator groove has a groove base, in particular a flat groove base, on which the synthetic rope lies, and two lateral groove flanks, whereby the pressure roller and the optional additional pressure roller protrude into the locator groove of the ejector roller and the pressure roller and the optional additional pressure roller are configured so that they protrude into the locator groove so that the synthetic rope is pressed by an outside circumferential surface of the pressure roller or by an outside circumferential surface of the additional pressure roller against the groove base, and that end surfaces of the pressure roller are in contact with the groove flanks of the ejector roller for the drive of the ejector roller by the pressure roller, or end surfaces of the additional pressure roller are in contact with the groove flanks of the ejector roller for the drive of the additional pressure roller by the ejector roller. The contour of the ejector roller formed by the locator groove and the contour of the pressure roller that is formed by the outside circumferential surface and the end surfaces of the pressure roller that protrudes into the locator groove, are therefore configured so that an increase of the force transmission to the synthetic rope, an avoidance of rope wear of the synthetic rope and an adaptation of the shape to the non-dimensionally stable synthetic rope is achieved, with which the flattening of the synthetic rope under load, which is a consequence of the design, is taken into account. Contours of this type and a shaping of the ejector roller and of the pressure roller of this type also make possible a simple drive of the ejector roller by the pressure roller which is actively driven by the drive motor by a transmission of force via the flanks between the end surfaces of the pressure roller and the groove flanks of the ejector roller, so that the ejector roller is not set in motion only by the synthetic rope but directly by the pressure roller. Contours of this type and a shaping of the ejector roller and of the additional pressure roller of this type also make possible a simple drive of the additional pressure roller by the ejector roller by a transmission of force via the flanks between the groove flanks of the ejector roller and the end surfaces of the additional pressure roller.

The outside circumferential surfaces that protrude into the locator groove and at least the areas of the end surfaces of the pressure roller that protrude into the locator groove are advantageously provided with a rubberized surface. With a rubberized surface on the outside circumferential surface, good force transmission values from the pressure roller driven by means of the drive motor and from the additional pressure roller on the synthetic rope can be achieved in a simple manner. With rubberized surfaces on the end surfaces of the pressure roller, a transmission of forces can be realized in a simple manner in the form of the transmission of forces via the flanks between the end surfaces of the pressure roller and the groove flanks of the ejector roller for the drive of the ejector roller by the pressure roller which is driven by the drive motor. With rubberized surfaces on the end surfaces of the additional pressure roller, a transmission of forces can be realized in a simple manner in the form of the transmission of forces via the flanks between the groove flanks of the ejector roller and the end surfaces of the additional pressure roller for the drive of the additional pressure roller by the ejector roller.

For this purpose, it is possible to realize the pressure roller in the form of a solid rubber roller. Alternatively it is possible to realize the pressure roller in the form of a steel roller, in which case the rubberized surfaces are vulcanized onto the pressure roller.

According to one advantageous embodiment of the disclosure, the pressure roller is biased by means of a bias device, in particular a spring device, toward the ejector roller. Consequently, a good wrapping of the synthetic rope around the ejector roller can be achieved in a simple manner.

Depending on the design of the forestry winch and the correspondingly different levels of ejector forces required on the rope, the number of driven pressure rollers can be adjusted as appropriate. For this purpose, depending on the type of forestry winch, one, two three or even more driven pressure rollers can be provided to achieve the required axial forces on the synthetic rope.

The drive motor that drives the pressure roller can be a hydraulic motor or an electric motor. When a plurality of driven pressure rollers are used, each driven pressure roller can be provided with its own drive motor, or a common drive motor can be provided for a plurality of driven pressure rollers, whereby the drive motor can drive a plurality of pressure rollers by means of a mechanical transmission such as a chain or belt drive, for example.

According to one advantageous development of the disclosure, the ejector has a rope ejector opening for the synthetic rope which is bordered laterally by two side plates, between which the synthetic rope is guided, whereby the side plates have rounded inside edges as rounded rope runout edges. As a result, the ejector has a rope ejector opening suitable for the synthetic rope. Because with the ejector according to the disclosure there is very low friction between the synthetic rope and steel bodies, with two side plates consisting of steel plates that have rounded inside edges, for example in the shape of segments of a circle, as rounded rope runout edges, it becomes possible in a simple manner to eliminate sharp edges on the surfaces of the side plates that come into contact with the synthetic rope with a lateral runout of the synthetic rope.

In one advantageous embodiment of the disclosure, the side plates are located laterally on the ejector roller, and have a circular circumferential surface in the vicinity of the rope ejector opening. Potentially damaging top and bottom edges on a rope runout for the synthetic rope are also eliminated in a simple manner.

In one advantageous development of the disclosure, the rope ejector opening is delimited vertically upward by a top limit pin and vertically downward by a bottom limit pin. When corresponding steel pins are used as top and bottom limit pins, it is possible in a simple manner to limit the rope runout of the synthetic rope on the ejector roller up and down in the vertical direction.

The disclosure further relates to a forestry winch that has a rope drum driven by a drive motor and an ejector according to the disclosure, whereby a synthetic rope is guided from the rope drum to the ejector roller and over the ejector roller. With the ejector according to the disclosure, a forestry winch is made available which can be used as a felling and/or pulling winch and which is provided with a synthetic rope, whereby the forestry winch has a user-friendly rope ejection requiring little effort on the part of the operator to pull the synthetic rope during the unspooling of the synthetic rope and little effort on the part of the operator to carry the synthetic rope as well as a good spooling quality of the synthetic rope on the rope drum.

### BRIEF DESCRIPTION OF THE DRAWINGS

Additional advantages and details of the disclosure are described in greater detail below with reference to the exemplary embodiments illustrated in the accompanying schematic figures, in which

FIG. 1 is a schematic illustration of a forestry winch according to the disclosure,

FIG. 2 is a detail A of the ejector roller in FIG. 1 in an enlarged schematic illustration,

FIG. 3 shows the ejector roller from FIGS. 1 and 2 with the rope ejector opening,

FIG. 4 is a head-on view of FIG. 3, and

FIG. 5 is a schematic illustration of an ejector roller with a plurality of pressure rollers according to the disclosure.

### DESCRIPTION OF THE DISCLOSURE

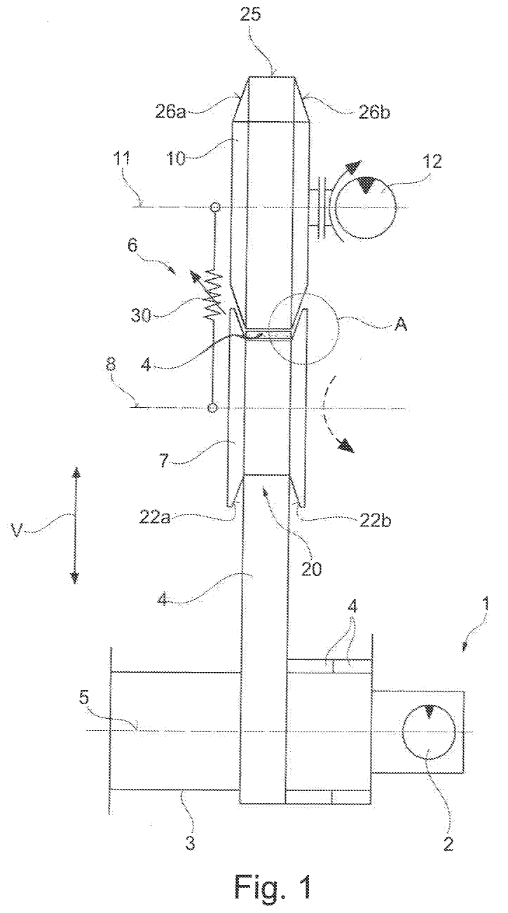

FIG. 1 is a schematic illustration of a forestry winch 1 according to the disclosure. FIG. 1 is a head-on view of the forestry winch 1 according to the disclosure.

The forestry winch 1 has a rope drum 3 which is driven by a drive motor 2 and on which a synthetic rope 4 is spooled. The rope drum 3 can rotate around an axis of rotation 5 and is driven by the drive motor 2. The drive motor 2 can be a hydraulic motor or an electric motor, for example.

The forestry winch 1 also has an ejector 6 with an ejector roller 7 which rotates around an axis of rotation 8.

The synthetic rope 4 is guided from the rope drum 3 in the vertical direction V to the ejector roller 7, guided over the ejector roller 7 and deflected on the ejector roller 7 so that the synthetic rope 4 is guided away from the ejector roller 7 in the horizontal direction.

The ejector 6 also has at least one pressure roller 10 which rotates around an axis of rotation 11 and by means of which the synthetic rope 4 is pressed against the ejector roller 7.

The pressure roller 10 according to the disclosure is actively driven by a drive motor 12. The drive motor 12 can be a hydraulic motor or an electric motor, for example.

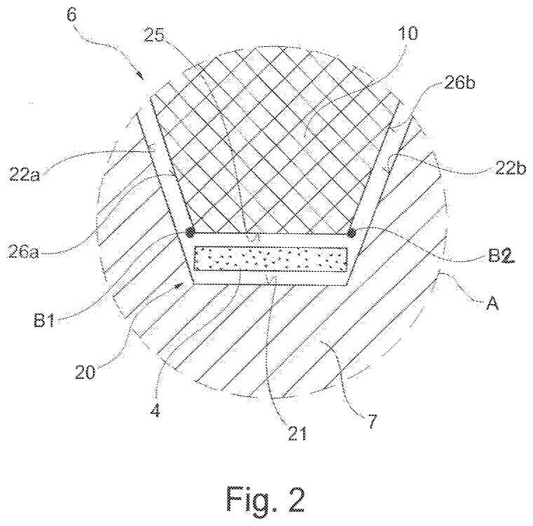

As illustrated in FIG. 2, in which the area A of the ejector 6 in FIG. 1 is shown on an enlarged scale, the ejector roller 7 has a locator groove 20 in which the synthetic rope 4 is located. The locator groove 20 has a flat groove base 21 on which the synthetic rope 4 lies and two lateral inclined groove flanks 22a, 22b. The pressure roller 10 driven by the drive motor 12 protrudes into the locator groove 20 of the ejector roller 7 and is designed so that the synthetic rope 4 lying on the groove base 21 is pressed by an outside circumferential surface 25 of the pressure roller 10 against the groove base 21 and two lateral and inclined end surfaces 26a, 26b of the pressure roller 10 are in contact with the groove flanks 22a, 22b of the ejector roller 7 for the drive of the ejector roller 7 by the pressure roller 10. In the illustrated exemplary embodiment, between the pressure roller 10 and the ejector roller 7, there is a transmission of force between the inclined end surfaces 26a, 26b of the pressure roller 10 and the groove flanks 22a, 22b of the ejector roller 7 for a rotational coupling between the pressure roller 10 driven by the drive motor 12 and the ejector roller 7. Alternatively between the inclined and surfaces 26a, 26b of the pressure roller 10 and the groove flanks 22a, 22b of the ejector roller 7, a gearing that is not sensitive to radial tolerances can be provided for the rotational coupling between the driven pressure roller 10 and the ejector roller 7.

The ejector roller 7 is preferably a steel roller.

To be able to transmit sufficient axial forces from the pressure roller 10 driven by the drive motor 12 to the synthetic rope 4 and to achieve a transmission of force by the pressure roller 10 driven by the drive motor 12 for the drive and rotation of the ejector roller 7, the external circumferential surface 25 that protrudes into the locator groove 20 and at least the areas of the two end surfaces 26a, 26b of the pressure roller 10 that protrude into the locator groove 20 are provided with a rubberized surface.

For this purpose, the pressure roller 10 is preferably formed by a steel roller onto which a rubber layer is vulcanized on the outside circumferential surface 25 and the two end surfaces 26a, 26b.

The ejector roller 10 is also biased toward the ejector roller 7 by means of a bias device 30. In the illustrated exemplary embodiment, the bias device 30 is an adjustable tension spring.

By means of the bias device 30, the pressure roller 10 is thus biased toward the ejector roller 7 so that the pressure roller 10 is in contact by means of its rubberized outside circumferential surface 25 with the synthetic rope 4 and the synthetic rope 4 is pressed against the groove base 21 of the locator groove 20 of the ejector roller 7, and the end surfaces 26a, 26b of the pressure roller 10 come into contact in areas B1, B2 with the groove flanks 22a, 22b of the ejector roller 7.

The shape of the locator groove 20 of the ejector roller 7 and the shape of the rubberized outside circumferential surface 25 and of the rubberized end surfaces 26a, 26b of the pressure roller 10 are thereby such that the flattening of the synthetic rope 4 under a tensile load is taken into consideration, so that an axial force can be applied to the synthetic rope 4 by the driven pressure roller 10 and in the areas B1, B2, a force transmission is achieved in the form of a transmission of force and drive by the flanks, as a result of which the ejector roller 7 is rotated and driven by the driven pressure roller 10.

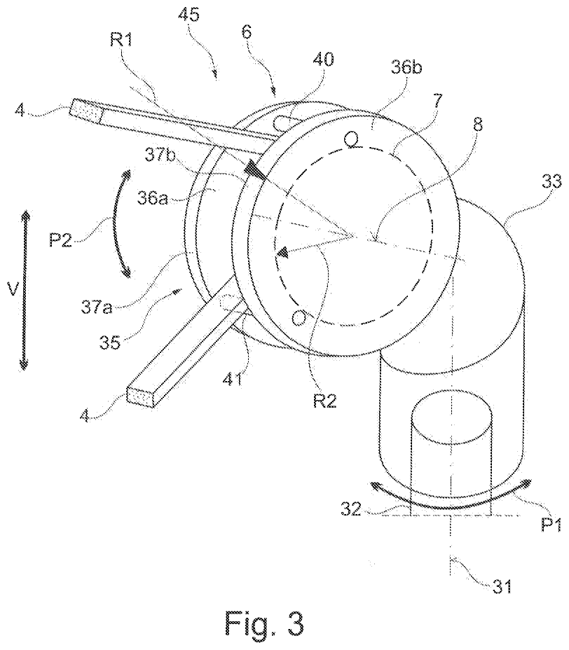

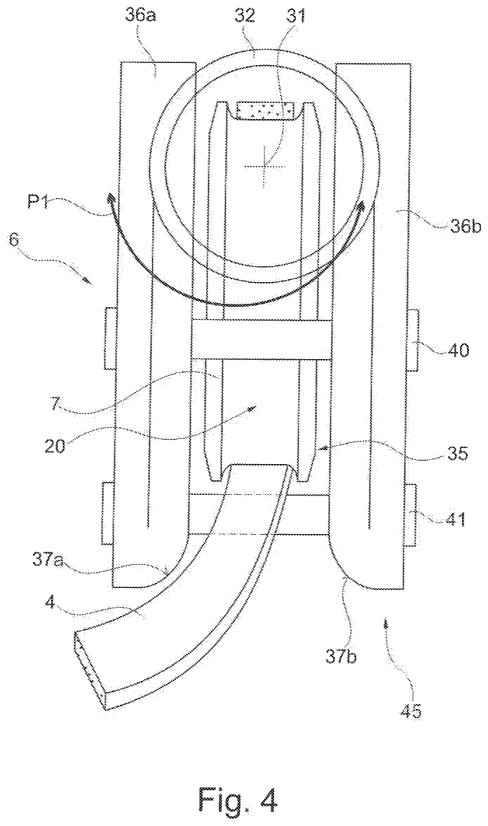

The ejector 6 with an ejector head 45 is illustrated in greater detail in FIGS. 3 and 4. The driven pressure roller 10 is not shown in any greater detail in FIGS. 3 and 4.

The ejector 6 has a bracket 33, with which the ejector 6 can be pivoted around a vertical pivoting axis 31, as illustrated by arrow P1 in FIGS. 3 and 4. The bracket 33 can comprise a tubular section 32 in which the synthetic rope 4 is guided to the rope drum 3.

The ejector head 45 forms a rope ejector opening 35 for the synthetic rope 4, which is delimited laterally by two side plates 36a, 36b, between which the ejector roller 7 rotates and the synthetic rope 4 is guided. The side plates 36a, 36b are fastened to the bracket 33.

The side plates 36a, 36b, which are made of steel, for example, and form the lateral boundaries of the rope ejector opening 35, each have a rounded inner edge 37a, 37b, which form corresponding rounded rope runout edges. With the rounded inner edges 37a, 37b, thus—as shown in FIG. 4—smooth rounded edges on the outer edges of the inner lateral flanks of the two side plates 36a, 36b are achieved, which represent the surfaces that come in contact with the synthetic rope 4 when the synthetic rope 4 is pulled laterally slightly out of the ejector head 45, as illustrated in FIG. 4. When the synthetic rope 4 is pulled laterally slightly out of the rope ejector opening 35 of the ejector head 45, sharp edges that might result in damage to the synthetic rope 4 are eliminated.

The rope ejector opening 35 formed by the two side plates 36a, 36b is delimited vertically upward by a top limit pin 40 and vertically downward by a bottom limit pin 41. The limit pins 40, 41 are preferably round steel pins which are fastened in the side plates 36a, 36b in a suitable manner.

In FIG. 3, the synthetic rope 4 is shown in an extreme top position which is delimited by the top limit pin 40, and in an extreme bottom position which is delimited by the bottom limit pin 41, whereby the synthetic rope 4—as indicated by the arrow P2 can be pulled out of the rope ejector opening 35 in any vertical extraction direction between them.

The side plates 36a, 36b have a circular outside circumferential surface, at least viewed in the circumferential direction, in the area between the two limit pins 40, 41. The outside radius R1 of the side plates 36a, 36b is larger than the outside radius R2 of the ejector roller 7. At least in the area viewed in the circumferential direction between the two limit pins 40, 41, the circular side plates 36a, 36b are provided with rounded inside edges 37a, 37b respectively.

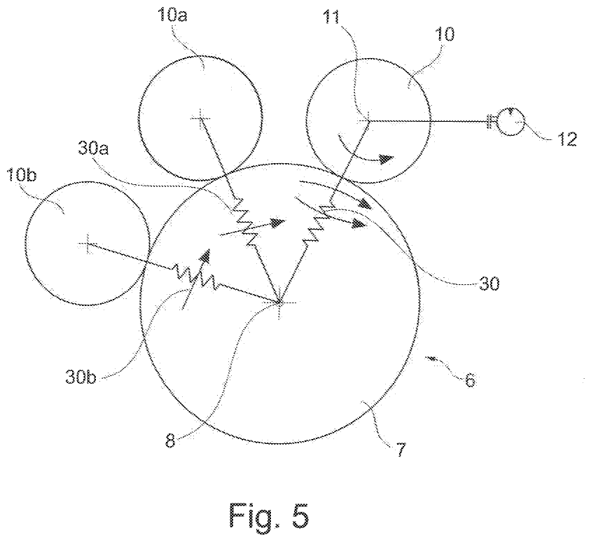

FIG. 5 shows an ejector with a plurality of pressure rollers 10, 10a, 10b, whereby in addition to the pressure roller 10 which is actively driven by means of the drive motor 12, at least one additional pressure roller 10a, 10b is provided. The additional pressure roller 10a or 10b preferably has an identical construction to the pressure roller 10 and is biased toward the ejector roller 7 by means of a corresponding bias device 30a or 30b.

The additional pressure roller 10a or 10b can be in the form of a pressure roller that is not actively driven by means of the drive motor or can be in the form of a pressure roller that is actively driven by means of the drive roller. The additional pressure roller 10 preferably protrudes, analogous to FIG. 2, into the locator groove 20 of the ejector roller 7 and is designed so that the synthetic rope 4 lying on the groove base 21 is pressed by an outside circumferential surface 25 of the pressure roller 10a or 10b against the groove base 21 and two lateral and inclined end surfaces 26a, 26b of the pressure roller 10a or 10b are in contact with the groove flanks 22a, 22b of the ejector roller 7 respectively.

Furthermore, analogous to the pressure roller 10, the outside circumferential surface 25 that protrudes into the locator groove 20 and at least the areas of the two end surfaces 26a, 26b of the additional pressure roller 10a or 10b that protrude into the locator groove 20 are provided with a rubberized surface.

If the additional pressure roller 10a or 10b is actively driven by means of the drive motor, each pressure roller 10, 10a, 10b can be driven by its own drive motor, or a common drive motor 12 can be provided for the drive of the pressure rollers 10, 10a, 10b and drive the pressure rollers 10, 10a, 10b by means of a mechanical transmission. With one or more additional driven pressure rollers 10a, 10b, the axial force transmitted to the synthetic rope 4 can be increased in a simple manner.

If the pressure roller 10a or 10b is not actively driven by means of the drive motor, preferably a force transmission is provided by the ejector roller 7 for the drive of the additional pressure roller 10a or 10b. This can be done, for example, analogous to the pressure roller 10 which is actively driven by the drive motor 12, by a flank transmission of force between the groove flanks 22a, 22b of the ejector roller 7 and the end surface 26a, 26b of the additional press roller 10a or 10b. The pressure roller 10a or 10b not actively driven by means of a drive motor is thereby driven by means of this flank transmission of force by ejector roller 7, which is in turn driven by the pressure roller 10 which is actively driven by means of the drive motor 12 by means of the corresponding transmission of force by the flanks.

The additional pressure roller 10a or 10b can have the same diameter as the pressure roller 10 which is actively driven by the drive motor 12. If appropriate for space reasons, the additional press roller 10a or 10b can also be sized with a smaller diameter than the pressure roller 10 which is actively driven by the drive motor 12.

While the present disclosure has been described in terms of the above detailed description, those of ordinary skill in the art will understand that alterations may be made within the spirit of the disclosure.

The invention claimed is:

1. An ejector for a forestry winch, the ejector comprising:
a rotating ejector roller by means of which a synthetic rope is guided and deflected, wherein the ejector has at least one rotating pressure roller driven by a drive motor and by means of which the synthetic rope is pressed against the ejector roller.

2. The ejector according to claim 1, wherein the at least one rotating pressure roller has a rubberized surface by means of which the at least one rotating pressure roller is in contact with the synthetic rope.

3. The ejector according to claim 1, wherein the driven at least one rotating pressure roller and the ejector roller are coupled in rotation.

4. The ejector according to claim 3, wherein, between the driven at least one rotating pressure roller and the ejector roller, there is a transmission of force for the drive of the ejector roller by the at least one rotating pressure roller.

5. The ejector according to claim 1, further comprising at least one additional rotating pressure roller not actively driven by the drive motor.

6. The ejector according to claim 5, wherein the additional rotating pressure roller and the ejector roller are rotationally coupled, and, between the ejector roller and the additional rotating pressure roller, a transmission of force for the drive of the additional rotating pressure roller by the ejector roller is provided.

7. The ejector according to claim 4, wherein the rotating pressure roller and/or the additional rotating pressure roller has a rubberized surface by means of which the rotating pressure roller and/or the additional rotating pressure roller is in contact with the ejector roller.

8. The ejector according to claim 1, wherein the ejector roller has a locator groove for the synthetic rope, wherein the locator groove has a groove base on which the synthetic rope lies, and two lateral groove flanks, wherein the at least one rotating pressure roller protrudes into the locator groove of the ejector roller and the at least one rotating pressure roller is configured so that the at least one rotating pressure roller protrudes into the locator groove, so that the synthetic rope is pressed by an outside circumferential surface of the at least one rotating pressure roller against the groove base, and that end surfaces of the at least one rotating pressure roller are in contact with the groove flanks of the ejector roller.

9. The ejector according to claim 8, wherein the outside circumferential surface that protrudes into the locator groove and at least the areas of the two end surfaces of the at least one rotating pressure roller that protrude into the locator groove are provided with a rubberized surface.

10. The ejector according to claim 2, wherein the rubberized surface is vulcanized onto the at least one rotating pressure roller.

11. The ejector according to claim 1, wherein the at least one rotating pressure roller is biased toward the ejector roller by a bias device.

12. The ejector according to claim 1, wherein the drive motor is a hydraulic motor or an electric motor.

13. The ejector according to claim 1, wherein the ejector has a rope ejector opening for the synthetic rope, which is delimited laterally by two side plates between which the synthetic rope is guided, wherein the side plates have rounded inside edges configured as curved rope runout edges.

14. The ejector according to claim 13, wherein the side plates are located laterally on the ejector roller, and in the vicinity of the rope ejector opening have a circular circumferential surface.

15. The ejector according to claim 13, wherein the rope ejector opening is delimited vertically upward by a top limit pin and vertically downward by a bottom limit pin.

16. A forestry winch, comprising:
a rope drum driven by a drive motor; and
an ejector according to claim 1, wherein the synthetic rope is guided from the rope drum to the ejector roller and over the ejector roller.
